(19) United States
(12) Patent Application Publication
(10) Pub. No.: US 2024/0406474 A1
(43) Pub. Date: Dec. 5, 2024

(54) TARGETED REQUEST ROUTING FOR AN ADAPTIVE BIT RATE SYSTEM

(71) Applicant: ARRIS Enterprises LLC, Horsham, PA (US)

(72) Inventors: Kanakendiran RAMACHANDIRAN, Chennai (IN); Varma CHANDERRAJU, San Jose, CA (US)

(73) Assignee: ARRIS Enterprises LLC, Horsham, PA (US)

(21) Appl. No.: 18/679,040

(22) Filed: May 30, 2024

(30) Foreign Application Priority Data
May 30, 2023 (IN) 202311037274

(51) Int. Cl. H04N 21/2347; H04N 21/235; H04N 21/2662

(52) U.S. Cl. CPC H04N 21/2347; H04N 21/2353; H04N 21/2662

(57) ABSTRACT

The present disclosure recites techniques for content delivery in an MABR system.

### CROSS REFERENCE TO RELATED APPLICATIONS

The present application claims priority to provisional Indian patent application No. 202311037274, filed on May 30, 2023 the contents of which are incorporated by reference herein.

### TECHNICAL FIELD

The present invention in general relates to a Multicast Adaptive Bit Rate (MABR) system. More particularly, but not exclusively, to techniques for secure content delivery in a Multicast Adaptive Bit Rate (MABR) system.

### BACKGROUND

In Multicast Adaptive Bit Rate (MABR) systems, for efficient content delivery to a user device (supported by an Adaptive Bit rate (ABR) player), a MABR server and MABR client device (also referred herein as client gateway) agree upon a common set of parameters. These common set of parameters provide information about the content to be delivered by the MABR client device to an Adaptive Bit Rate (ABR) player and thereafter to the user device. In addition, the MABR client device should be able to determine the required parameters for each media segment request originating from the ABR player. These parameters may include content identifiers, upstream information, operator specific information, if any and like parameters that are used for efficient content delivery. Further, the content identifiers parameters may include channel ID (unique identifier for an ABR content) and representation ID (unique identifier for a variant stream within the content), whereas upstream information may include HTTP(S) CDN URL of the ABR content.

Traditionally, the derivation/retrieval of these common set of parameters is generally done by relying on the format of the content request, received in the form of a URL. The two most common approaches followed for derivation/retrieval of these common set of parameters include: (1) a packager producing the URL with all the necessary information in a pre-defined format, in which technique the MABR client device and the MABR server may do a regex-based parsing to retrieve those values; and (2) configuring the URL prefix that maps to those parameters and a service to retrieve the information then MABR client device and the MABR server may use this service to obtain the parameters.

The information disclosed in this background section is only for enhancement of understanding of the general background of the invention and should not be taken as an acknowledgement or any form of suggestion that this information forms the prior art already known to a person skilled in the art.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and with reference to the accompanying Figures, in which:

FIG. 1 illustrates an architecture of a Multicast Adaptive Bit Rate (MABR) system interacting with plurality of Content Delivery Network (CDN) for efficient content delivery.

FIG. 2 shows a block diagram of an MABR Client device as illustrated in FIG. 1.

FIG. 3 illustrates another architecture of a Multicast Adaptive Bit Rate (MABR) system interacting with plurality of Content Delivery Network (CDN) for efficient content delivery.

FIG. 4 illustrates a process for using a Multicast Adaptive Bit Rate (MABR) system.

FIG. 5 illustrates a sequence diagram for a modified configuration of a Multicast Adaptive Bit Rate (MABR) system.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “at least one” and “one or more” may be used interchangeably or in combination throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

The present disclosure describes methods, systems, and computer readable media for effective integration of plurality of Content Delivery Network (CDN) with a Multicast Adaptive Bit rate (MABR) system to provide efficient content delivery to end users. The MABR system reduces high bandwidth consumption experienced due to ever-increasing usage of Over the Top (OTT) platforms, that are unicast based content delivery system, by multicasting the OTT content to MABR client devices/client gateway in the client side which can then serve the in-house ABR player devices which results in significant bandwidth savings. In the MABR system when an ABR player requests the MABR client device for a media segment, the MABR client device first checks if it is available in its cache (obtained over multicast) and delivers it. If not available in the cache, the MABR client device fetches the segment from the upstream CDN and delivers it to the ABR player.

To make the multicast system more efficient, the MABR server and MABR client device agree upon a common set of parameters that gives information to the MABR client device about the content requested by the ABR player. In addition, the MABR client device should be able to determine the required parameters for each media segment requested by the ABR player.

The derivation/retrieval of these common set of parameters is generally done by relying on the format of the content URL prepared by a packager. One common approach used for retrieval of these common set of parameters is that a packager produces the URL with all the information in a pre-defined format and the MABR client device and the MABR server may do a regex-based parsing to retrieve these parameters. Another approach is configuring the URL prefix that maps to those parameters and a service to retrieve this information.

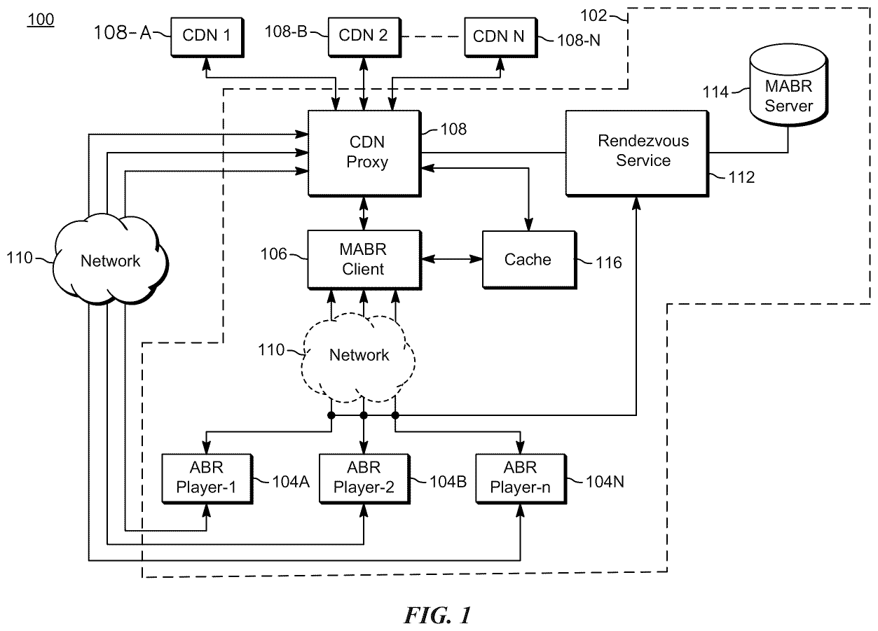

Referring now to FIG. 1, an exemplary high-level architecture 100 illustrating a Multicast Adaptive Bit Rate (MABR) system 102 with a plurality of Content Delivery Network (CDN) 108, for content delivery, is shown. The architecture 100 discloses the MABR system 102 comprising a plurality of Adaptive Bit Rate (ABR) Players represented by 104-A, 104-B and 104-N. The ABR players 104-A, 104-B and 104-N are configured to provide multimedia content, streamed through a content source, to end users (not shown) for viewing based on the available network bandwidth. To access the content requested by the end user (not shown), the ABR player 104-A, 104-B, 104-N remains in communication with an MABR client device 106 also referred herein as client gateway device and a Content Delivery Network (CDN) proxy server 108 through a network 110.

In an aspect, FIG. 1 depicts a broad architectural overview of the MABR system 102 integrated with the plurality of content delivery network's (CDN) 108. Other system, units, elements, and/or components may be included as part of the architecture 100. In another aspect, FIG. 1 discloses an exemplary embodiment representing “N” number of ABR players 104 (A-N) connected to the MABR client device 106 and the CDN proxy server 108. However, for the sake of brevity, going further throughout the disclosure the ABR player may be simply referred as 104, which means that the disclosure refers to any of the ABR players among “N” ABR players and is not intended to be construed as limiting in any sense.

Any of the content sources may comprise various contents such as, but not limited to, any combination of video and audio contents, Internet web pages, or interactive games. In a non-limiting embodiment, the one or more content sources may comprise content servers of over the top (OTT) applications such as YouTube, YT Music, Apple Music, Netflix, Amazon Music, Spotify, Prime Videos, and the like. In one example, the video content may be live events, such as basketball games, football games, concerts, among other events. In another example, the video content may be broadcast based content, such as regular video programming provided at designated times. In another non-limiting embodiment, any of the content sources may comprise any content server such as content servers of, but not limited to, Amazon, Facebook, Instagram, Wikipedia, Google books, Chrome, Twitter etc. The content servers of any of the content sources (not shown) may be accessed using dedicated application or using web browsers.

Whereas, the network 110 referred in the disclosure may comprise a data network such as, but not restricted to, the Internet, Local Area Network (LAN), Wide Area Network (WAN), Metropolitan Area Network (MAN), etc. In certain embodiments, the network 110 may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the network 110 may include or otherwise cover networks or subnetworks, each of which may include, for example, a wired or wireless data pathway.

Referring again to FIG. 1, a primary/initial manifest (also known as master manifest) request (which is in the form of an URL) is generated by an ABR player 104. In an exemplary embodiment, the initial manifest request is generated by the ABR player 104 in response to receiving a content request from a user device (not shown). The initial manifest request is then shared with the upstream CDN proxy server 108. The upstream CDN proxy server 108 modifies the received primary manifest by adding a query parameter to it. Specifically, the upstream CDN proxy server 108 modifies the initial manifest request by adding an identifier that captures CDN base URL information as the query parameter.

The modified initial manifest URL is thereafter transmitted back to the ABR player 104 from where the modified initial manifest request is retransmitted to a rendezvous service 112. It is during this redirection the CDN information may be lost from initial manifest request and thus CDN base URL information may be added as the query parameter to the initial manifest request by the CDN proxy server 108. Upon receiving the modified initial manifest request, the rendezvous service 112 is configured to perform mainly two functionalities (1) performing a lookup operation, at an MABR server 114, to identify MABR client device 106 associated with a user device information contained within the modified initial manifest request and (2) performing a reverse lookup operation, at the MABR server 114, to identify the channel ID to which the modified initial manifest relates to.

After the look-up operations are completed, the rendezvous service 112 is configured to update the modified initial manifest request by adding a channel ID, upstream CDN base URL information, and/or operator specific information if any, derived from the above lookup operations. In an exemplary embodiment, the process of updating performed at the rendezvous service 112 may also be referred as translation of the initial manifest request as this process translates the modified initial manifest request to include a channel ID, upstream CDN base URL information and/or operator specific information. The translated manifest request is thereafter shared with the ABR player 104. In an exemplary aspect, the rendezvous service 112 may be configured to translate only the initial manifest request coming from the ABR player 104. Thereafter, all the ABR player's 104 manifest/media segment requests are directly passed to the MABR client device 106. At ABR player, the manifest/media segment request is translated for the second time.

In an exemplary embodiment, the configuration like the channel ID and operator specific information pertaining to the whole content may be pre-configured at the MABR server 114. Further, the ABR player 104 may have a catalogue published by the packager that contains a direct list of different channels and master manifest URL. In addition, the catalogue of ABR content URLs that may be served by the MABR system 102 may contain the mapping of the ABR content URL and the configuration of the content stored at the MABR server 114.

The rendezvous service 112 may translate the initial request from the ABR player 104 to include information including channel ID and/or upstream CDN base URL information to the initial manifest request and operator specific information, if any, to the redirected URL path. Further, this information may be updated in the form of metadata. In an example, each parameter may be added as a name=value pair in the URL path, as exemplified below in the highlighted portion. However, the parameter name may have a unique prefix to avoid any collision and for easier extraction.

https://clientgw.mabr.com/csmabr-channelid=fox_hls/contents/fox/manifest.m3u8

In the above exemplary URL, “csmabr-channelid” is the channel id parameter added to the original URL which is https://clientgw.csmabr.com/contents/fox/manifest.m3u8. “csmabr-” is the prefix, wherein the translated URL the location of the parameter is irrelevant. In another exemplary embodiment, this information may also be included in the translated manifest request in the form of relevant metadata in a compact binary format (e.g. protobuf) and Base-64 encode it. However, the technique of adding metadata is helpful especially if there are more parameters to be added in the manifest Request URL.

The below example may be considered to understand as to how the translation of the initial manifest request takes place during the rendezvous service 112. An exemplary primary manifest URL translation for an HLS case may be as follows:

Primary Manifest URL is represented by: https://cdn1.example.com/live/fox_hls/hls.m3u8; where Channel ID is: fox_hls; and client GW URL is: https://gw.csmabr.com

The Channel ID and Client GW URL may be part of the configuration. The Channel ID is obtained by doing a lookup using the manifest request. Thus, after translation at the rendezvous service 112 the translated output manifest request appears as:

https://gw.csmabr.com/csmabr-cdnbase=https%3A%2F%2Fcdn1.example.com/csmabr-channelid=fox_hls/live/fox_hls/hls.m3u8.

The csmabr-cdnbase parameter contains the URL encoded base URL of the original request to the rendezvous service 112. Further, this parameter may be used by the MABR client device 106 to fetch the media segments from the upstream CDN in case of a cache miss.

After the initial manifest request is translated by the rendezvous service, the content requests, originating from the ABR player 104, are passed through the MABR client device 106. This gives an opportunity to the MABR client device 106 to read and rewrite the URLs present in the manifest request. In an exemplary embodiment, the MABR client device 106 may parse incoming manifest URLs and may derive the representation IDs for the same. In particular, as shown in FIG. 1, the translated initial manifest request may be shared with the MABR client device 106.

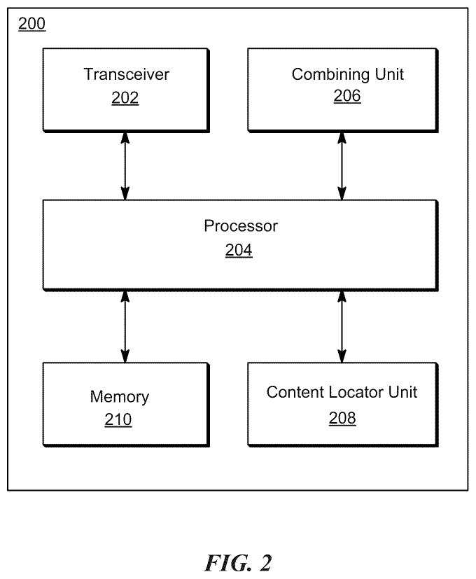

Further, referring to FIG. 2 in conjunction with FIG. 1, it may be appreciated that the MABR client device 106/200 is shown having a transceiver 202 configured to receive manifest requests from an ABR player 104. In an exemplary embodiment the initial manifest request is redirected to the MABR client device 106 by a rendezvous service 112 upon updating/translating the manifest request with a channel ID and an upstream CDN base information and thereafter the subsequent content/manifest request from the ABR player 104 are directly received by the transceiver 202 of the MABR client device 106. The MABR client device 106 may also include a processor 204 operatively coupled to the transceiver 202. The processor 204 may be configured to translate, once again, the received manifest request by adding the representation ID, wherein the representation ID uniquely identifies a variant stream within an ABR content. In a specific embodiment, to translate the manifest request, the processor 204 of the MABR client device 106 is configured to fetch the manifest from the upstream CDN proxy server 108 in response to receiving the manifest request from the ABR player 104 and subsequently derive the representation ID from the fetched manifest. Further, as shown in FIG. 2, the MABR client device 106 may also include a combining unit 206 operatively coupled to the processor 204. The combining unit 206 is configured to obtain a stream ID by combining the channel ID and the representation ID contained within the translated manifest request, wherein the stream ID is configured to uniquely identify a variant stream in the entire MABR system 102.

FIG. 2, in addition may include content locator unit 208 operatively coupled to the processor 204. The content locator unit 208 may be configured to perform a look up in a cache 116 for the media content requested in the translated manifest request using the stream ID. In that case, the same content has been requested earlier over the multicast system, the MABR system 102 may have it stored in the cache 116 and may be able to provide the media content requested in the translated manifest URL, i.e., in case of cache hit. Alternatively, if the content has not been requested over the MABR system 102 earlier by the ABR player 104 and the content locator unit 208 in unable to find a hit in the cache 116, the MABR client device 106 may redirect the request to CDN proxy server 108. The CDN proxy server 108 may reach out to numerous upstream CDN's 108-1A, 108-1B . . . 108-1N connected to the CDN proxy server 108, as shown in FIG. 1. In particular, the CDN proxy server 108 may fetch the requested media segments from one of the upstream CDN's 108-1A, 108-1B . . . 108-1N and provide it to the MABR client device 106 which may then share the requested content with the ABR player 104.

In an exemplary embodiment, the processor 204 may include, but is not restricted to, a general-purpose processor, a Field Programmable Gate Array (FPGA), an Application Specific Integrated Circuit (ASIC), a Digital Signal Processor (DSP), microprocessors, microcomputers, micro-controllers, digital signal processors, central processing units, state machines, logic circuitries, and/or any devices that manipulate signals based on operational instructions. Further, a memory 210 may be communicatively coupled to the processor 204. The memory 210 may comprise various data and one or more instructions that are executable by the processor 204 and may be required to translate the manifest request URL received from the ABR player 104. The memory 210 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth.

In a non-limiting embodiment, two types of memory may be primarily used by the MABR Client device 106 i.e., RAM and Flash memory (not shown in Figures). The RAM is a memory that is available to the processor 204 when the MABR Client device 106 is booted up and running. RAM is used to run and execute applications, but RAM loses its contents when the MABR Client device 106 is turned off or if the content is not refreshed by an external charge. Thus, RAM is considered volatile memory. On the other hand, the flash memory is non-volatile in nature and may store core applications of a cable video service, which include firmware, middleware etc.

In a non-limiting embodiment, all components of the MABR client device 106 may be integrated onto a single chip named as a system on a chip (SoC). The SoC is an integrated circuit that takes a single platform and integrates an entire electronic or computer system onto it. This embodiment is particularly helpful for reducing the energy waste, saving the spending costs, and reducing the space occupied by individual components.

The above techniques may be described in the general context of computer executable instructions. Generally, computer executable instructions can include routines, programs, objects, components, data structures, procedures, modules, and functions, which perform specific functions or implement specific abstract data types. In one aspect, the methods may be performed by an apparatus comprising the processor 204 and the memory 210 of the MABR client device 106.

The order in which the various operations of the techniques are described is not intended to be construed as a limitation, and any number of the described method flow steps can be combined in any order to implement the method. Additionally, individual blocks may be deleted from the techniques without departing from the spirit and scope of the subject matter described herein. Furthermore, the techniques can be implemented in any suitable hardware, software, firmware, or combination thereof.

The various operations of techniques described above may be performed by any suitable means capable of performing the corresponding functions. The means may include various hardware and/or software component(s) and/or module(s), including, but not limited to the processor 204 of FIG. 2 and the various units of FIG. 2. Some operations of the techniques may be implemented at an external server as well.

In a non-limiting embodiment, one or more non-transitory computer-readable media may be utilized for implementing the embodiments. A computer-readable media refers to any type of physical memory (such as the memory 210) on which information or data readable by a processor may be stored. Thus, a computer-readable media may store one or more instructions for execution by the processor 204, including instructions for causing the processor 204 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a non-transitory computer readable media having instructions stored (and/or encoded) thereon, the instructions being executable by one or more processors to perform the operations described herein. For certain aspects, the computer program product may include packaging material.

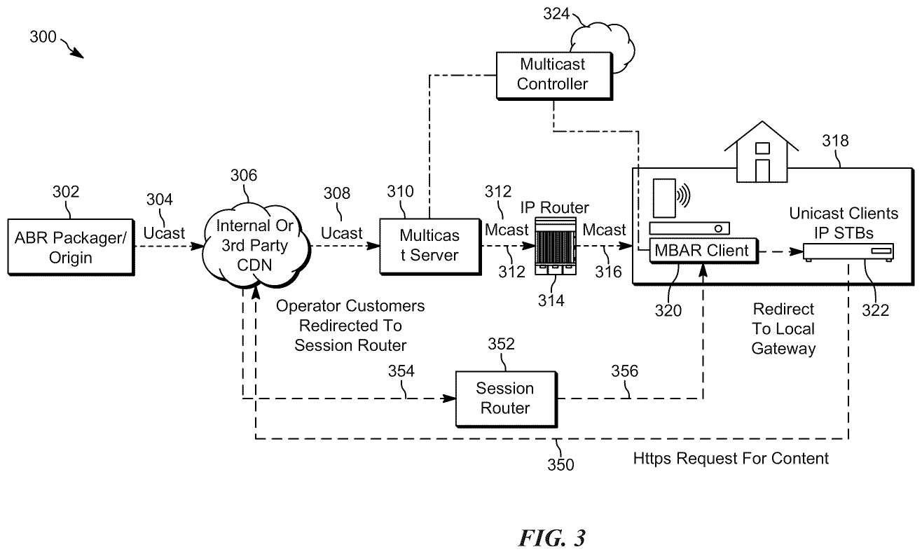

Referring to FIG. 3, another exemplary high-level architecture 300 of a Multicast Adaptive Bit Rate (MABR) system with a plurality of Content Delivery Network (CDN), for content delivery, is illustrated. An adaptive bit rate packager/origin 302 packages together the different video content that may be provided to a client. The adaptive bit rate packager/origin 302 provides a unicast transmission 304 to an internal and/or third part content delivery network (CDN) 306. The unicast transmission is a one-to-one transmission from one point in the network to another point in the network, that is, one sender and one receiver, each identified by a network address. Multicast and broadcast is a one-to-many transmissions from one point in the network to many points in the network, that is, one sender and many receivers, each identified by a network address. The internal and/or third part content delivery network (CDN) 306 provides a unicast transmission 308 to a multicast server 310 which has a principal function of providing a multicast transmission of video content. The multicast server 310 provides a multicast transmission 312 to an IP router 314. The IP router 314 provides a multicast transmission 316 to one or more client 318 (one shown). By way of example, each of the clients 318 may represent a residence or a business or other location for the consumption of the video content. Each of the clients 318 may include a Multicast Adaptive Bit Rate (MABR) client 320 and a unicast client 322. The Multicast Adaptive Bit Rate (MABR) client 320 is often included together with a gateway and/or modem at the respective client 318, such as a cable modem. The unicast client 322 is often a television, a set top box, a laptop, a tablet, a mobile phone, or any other suitable device for receiving and rendering content. By way of example, the content provided to the unicast client 322 may be HLS and/or DASH. A multicast controller 324 may provide control information to the multicast server 310 and the MABR client 320, including any other suitable device. The multicast controller 324 provides the management functionality to the system to select, organize, and provide the multicast content. For example, the multicast controller 324 may direct the multicast server 310 to create a respective multicast session for particular video content and informs the respective MABR clients 320 to use the multicast session for the particular video content.

By way of example, a unicast client 322 initiates a session, such as for example a live football game. The unicast client 322 typically attempts to initiate a session by forming a connection with the CDN 306 for the content such as by using a HTTPS request for content 350. However, in the event that the content is already being provided as a multicast transmission or is suitable for being provided as a multicast transmission, the CDN 306 may redirect 354 the HTTPS request for content 350 to a session router 352. The session router 352 may redirect the request 356 from the unicast client 322 to the MABR client 320 so that the content is being provided to the unicast client 322 from the multicast transmission 316 being received by the MABR client 320. The session router 352 provides the information to the appropriate client 318, among potentially thousand or tens of thousands of such clients. By way of example the MABR client 320 may have already tuned to the multicast transmission 316 and it is available in a local cache.

In order to effectively perform the steering of the video transmissions using a multicast transmission, both the CDN 306 and/or the session router 352 rely on some identifying information that the media player application includes in its initial request to the CDN 306 for content. Otherwise, the CDN 306 and/or the session router 352 would not be aware of where to do the redirect to and how to redirect the request. Thus, the CDN 306 may determine that the request is received from a subscriber that includes an associated MABR client 320, and uses information included in the request to redirect the request to the session router 356. The session router 356 may also use the identifying information to determine which client 318, and in particular, which MABR client 320 should the request be routed to.

In many implementations, it is desirable to have all communications use an encrypted communication technique, such as for example, Hypertext Transfer Protocol Secure (HTTPS) which is an extension of the Hypertext Transfer Protocol (HTTP). HTTPS uses encryption for secure communication over a computer network, and is widely used on the Internet. In HTTPS, the communication protocol is encrypted using Transport Layer Security (TLS) or, formerly, Secure Sockets Layer (SSL). The protocol is therefore also referred to as HTTP over TLS, or HTTP over SSL.

The principal motivations for HTTPS are authentication of the accessed device and protection of the privacy and integrity of the exchanged data while it is in transit. HTTPS protects against man-in-the-middle attacks, and the bidirectional block cipher encryption of communications between a client and server protects the communications against eavesdropping and tampering. The authentication aspect of HTTPS requires a trusted third party to sign server-side digital certificates.

To increase the security of the system, it is desirable that all of the communications are encrypted, such as using HTTPS, including the communication between the unicast clients 322 and the MABR client 320, the IP router 314 and the MABR client 320, the multicast server 310 and the IP router 314, the internal or third party CDN 306 and the multicast server 310, the internal or third party CDN 306 and the session router 352, the session router 352 and the MABR client 320, and/or the multicast controller 324 and any of the other devices. Also, the encrypted communications may be between other devices in the system, as desired. It is noted that each of the MABR clients 320 which will provide the role of a server of video content to the unicast clients 322 are each expected to have a server-side digital certificate. However, in a typical deployment within a cable networking system, there may be tens of thousands of such MABR clients 320, and thereby require tens of thousands of such server-side digital certificates. Further, to maintain security it is desired that each of such server-side digital certificates is unique. Also, each of such MABR clients 320 would also need a fully qualified domain name (FQDN). A fully qualified domain name (FQDN), sometimes also referred to as an absolute domain name, is a domain name that specifies its exact location in the tree hierarchy of the Domain Name System (DNS). It specifies all domain levels, including the top-level domain and the root zone. A fully qualified domain name is distinguished by its lack of ambiguity in terms of DNS zone location in the hierarchy of DNS labels in that it can be interpreted only in one way. Moreover, the server-side digital certificate and the fully qualified domain name for each MABR client 320 should match each other.

One technique for providing configuration for the unicast client 322 to use the MABR client 320 is for the manifest URL to point to a fully qualified domain name (FQDN). A local Domain Name System (DNS) resolver in each in-home 318 deployment would resolve that same (fixed or static) fully qualified domain name (FQDN) to the Internet Protocol (IP) address of the device on which the MABR client 320 resides. However, this technique results in security concerns because all the MABR clients 320 would need to use the same certificate that corresponds to the same FQDN as a result of having the same host name.

Another technique for providing configuration for the unicast client 322 to use the MABR client 320 is for an external rendezvous service (e.g., session router) to receive a unique identifier (e.g., such as a device ID, a subscriber ID, etc.) in the initial manifest request from the unicast client 322. The unique identifier may be used to look up information about the subscriber and the device (e.g., CPE) from where the request is originating and that can be used to determine how to route or steer the request to the appropriate MABR client 320 (e.g., residing on the local gateway in the subscriber's household). Unfortunately, this technique may require deriving a unique device id and adding it to the initial manifest request, which is performed by modifying the unicast client 322, which is not desirable in order to permit a maximum number of different unicast clients 322 to be used.

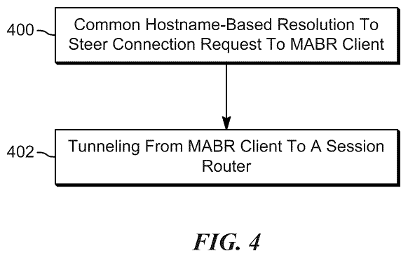

Referring to FIG. 4, a modified process is illustrated for routing of the unicast clients 322 to the MABR client 320 within an encrypted environment that maintains the security without imposing additional limitations on the unicast client 322 devices. The technique preferably uses a common (e.g., fixed) hostname-based resolution 400 to initially steer the connection request from the unicast client 322 in a household to the MABR client 320 on a device in the same household. Once that's accomplished, the technique may use tunneling 402 from MABR client 320 to a session router 352 service to achieve two objectives. The first is secure forwarding of the request from the unicast client 322 to an upstream service (e.g., session router 352). The second is using the same tunnel to provide information about the MABR client 320 FQDN to the upstream service (e.g., session router 352), so the upstream service can issue a HTTPS redirect that directs the unicast client 322 to the MABR client 320 on the local device. Preferably, the process primary operates at the TCP layer and adds metadata that can be used for re-directing to MABR client's 320 FQDN URL by the session router 352. The communication between the unicast client 322 and the session router 352 is tunneled through the MABR client 320 over TLS (encrypted channel).

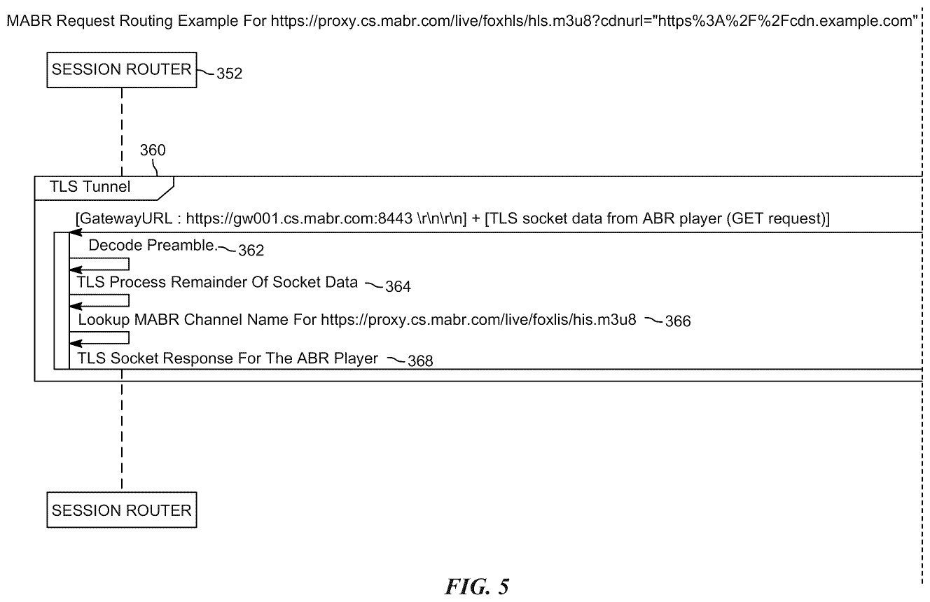

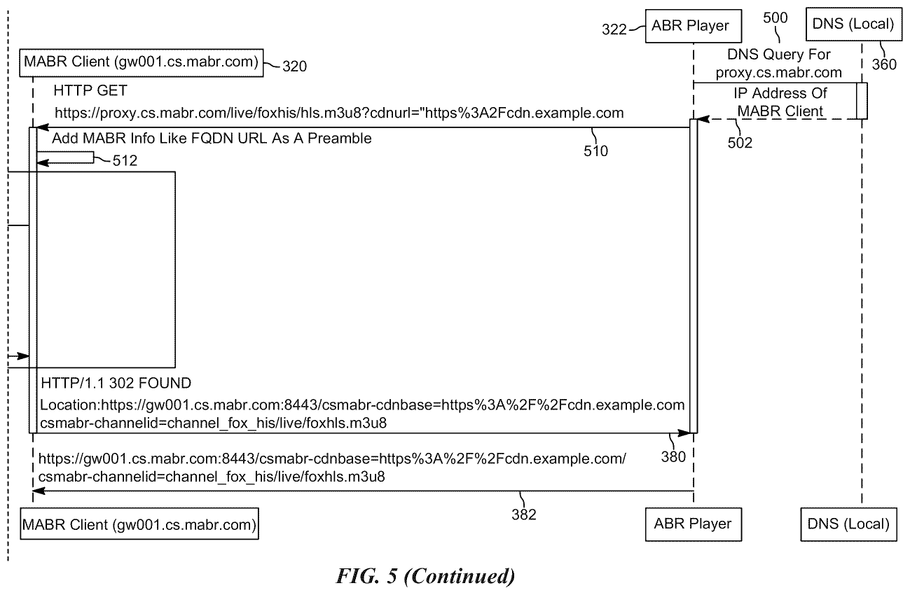

Referring to FIG. 5, a sequence diagram is illustrated for routing of the unicast clients 322 to the MABR client 320 within an encrypted environment. The four principal components include the session router 352, the MABR client 320, the unicast client 322 (e.g., ABR player), and a local DNS 360. For example, the MABR client 320 residing in the gateway may have a FQDN address of (gw001.cs.mabr.com) and it will have a certificate that may uniquely identify that domain (i.e., gw001.cs.mabr.com) on the gateway. Typically, the MABR client 320 is residing on a gateway and the gateway includes a certificate that corresponds to the domain on the gateway.

The MABR request routing may include, for example, https://proxy.cs.mabr.com/live/foxhls/hls.m3u8?cdnurl=“https%3A%2F%2Fcdn.example.com”

The domain proxy.cs.mabr.com is owned by the session router 352 and only the session router 352 can decode the https traffic for this domain.

To play this URL, the unicast client 322 initially does a DNS query 500 to the local DNS 360 to identify the address of the domain proxy.cs.mabr.com. The local DNS 360 resolves the query by providing the IP address 502 of the MABR client 320 (e.g., the gateway on which the MABR client 320 resides) to the unicast client 322.

The unicast client 322 with the IP address of the MABR client 320 makes a request 510, such as in the form of a HTTP GET, for the desired content. For example, the HTTP GET may be of the form of-https://proxy.cs.mabr.com/live/foxhls/hls.m3u8?cdnurl=“https%3A%2F%2Fcdn.example.com. The MABR client 320 may listen on TCP socket port 443 for such requests, although any suitable manner and/or port for listening may be used. The MABR client 320 opens a TCP socket to accept the traffic. The MABR client 320 proxies communication between the unicast client 322 and the session router 352. The session router 352 owns proxy.cs.mabr.com and is the transport layer security (TLS) end-point for the request, thus the session router 352 is the only device for the decryption of the request using its private key.

If the traffic is forwarded alone, the session router 352 will not have sufficient information to determine from where the request has originated, because such requests may originate from any one of tens of thousands of such devices. To provide identification of the origin of such a request, the MABR client 320 adds metadata 512 to the request, such as a FQDN URL as a preamble to the request. In this manner, the session router 352 will have sufficient information to identify the MABR client 320 and/or the unicast client 322. By way of example, the metadata may be the name, followed by the value, followed by other characters. The gw001.cs.mabr.com portion of the request uniquely identifies the household from which the request originated.

It is desirable that the MABR client 320 sends the resulting request in an encrypted manner to the session router 352, such as using some form of encryption, such as for example a TLS tunnel 360. However, the additional metadata portion of the request may be sent as clear text, if desired, although a man-in-the-middle attack is possible if it is sent in clear text. The session router 352 opens a TLS socket so the session router 352 may accept the traffic from the MABR client 320 and provide traffic from the session router 352 to the MABR client 320. Also, the TLS tunnel 360 increases the security associated with the added preamble data creating a more secure environment.

Upon the session router 352 receiving the data from the MABR client 320, the session router 352 decodes the preamble 362, which provides the information to identify the origin of the request for the data. The session router 352 processes the remainder of the socket data 364 using TLS, depending on the encryption technique used. The session router 352 may look up the MABR channel name for the particular URL 366, such as, https://proxy.cs.mabr.com/live/foxhls/hls.m3u8. In this manner, the session router 352 may determine a particular channel for the MABR client 320 where the content may be obtained. The session router 352 may provide a TLS socket response 368 for the unicast player 322 to the MABR client 320. This TLS socket response 368 contains the re-direct response where the TLS end-point is the unicast player 322.

The MABR client 320 receives the TLS socket response 368 and forwards 380 the TLS socket response 368 to the unicast client 322. The received TLS socket response 368 provides information in the form of a redirect 380 for obtaining the desired information from the MABR client 320 in a manner that is transparent to the unicast client 322. For example, gw001.cs.mabr.com: 8443 provides the information of where to obtain the requested video content from the local MABR client 320, which corresponds to the metadata that was provided to the session router 352. The unicast client 322 uses the redirect 380 to provide a request 382 to the MABR client 320 for the content. It is noted that this technique maintains encrypted communications among all, or at least portions of, the communications between different components of the system. Further, the MABR client 320 may decrypt the communications because it has a certificate for gw001.cs.mabr.com.

By way of example, the manifest URL takes the form: https://proxy.cs.mabr.com/hls/cnn/hls.m3u8?mabrCdn=“https://cdn.example.com”
(1) The host of the manifest URL (proxy.cs.mabr.com) may be resolved by the local DNS to the MABR client (similar to DNS routing).
(2) the MABR client may run a plain TCP socket server at 443 (default HTTPS port) which serves as an end-point for the player's initial manifest request. The session router may run a TLS TCP socket server at 443 which serves as an end-point to the MABR client for tunnelling the player's initial manifest request. The MABR client proxies the communication between player and session router.
(3) MABR client may compose metadata (E.g., URL with FQDN owned by MABR client) that can help session router to re-direct the request to the MABR client via the player.
(4) MABR client may send the metadata as a preamble (at the beginning of the connection), followed by the data sent by the player (TLS hand-shake, followed by GET request data).
(5) The session router may receive the preamble, decode it, and create a context to handle this request. The data followed by the preamble is handed-off for regular TLS processing.
(6) The session router may issue a HTTPS redirect (302/307) response pointing to MABR client using the FQDN URL that was communicated to session router by the MABR client as part of the preamble.
(7) The MABR client may be authenticated by the media player app using the unique certificate (that matches its own unique FQDN) that's furnished by MABR client.

Although the previous description addresses a particular requirement in the MABR system to facilitate the delivery of managed content using MABR, it can be applied to other systems and scenarios. The same techniques may be used to steer requests from media applications for unmanaged (or OTT) content to the local MABR client. In addition, it should be noted that this transparent, secure, and targeted request routing technique has applicability beyond MABR systems. The techniques may be employed in any system where there is a desire for an application to be transparently and securely steered towards a local and more proximate endpoint without requiring any changes to the application itself and without any visible intervention from the user or the application.

The technique may be used for un-managed content or OTT content. Typically this refers to content that is not directly owned and managed by the service provider. The service provider's network is merely carrying that content over-the-top on their network and delivering that from the CSP (Content Service Provider) to the subscribers. CSPs typically distribute their content via CDNs. These CDNs are typically third party owned and operated i.e. not under the direct control of the CSP or the service provider but in some cases could be owned and managed either by CSP or the service provider. For unmanaged or OTT content, the system may use the CDN to issue a re-direct to the manifest URL. For instance, cdn.example.com CDN on receiving https://cdn.example.com/hls/cnn/hls.m3u8 and identifying this request is from a subscriber in MABR service provider domain could re-direct it to https://proxy.cs.mabr.com/hls/cnn/hls.m3u8?mabrCdn=“https://cdn.example.com”. This may be accomplished using rules that are typically employed by CDN vendors to identify the source of requests and steer those requests to the most proximate caching (CDN) locations.

The various illustrative logical blocks, modules, and operations described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

We claim:

1. A method for providing content to a client device comprising:
(a) a Multicast Adaptive Bit Rate (MABR) device receiving an encrypted request for content from said client device;
(b) said MABR device modifying said encrypted request from said client device, without decrypting said encrypted request, and providing said modified encrypted request to a session router;
(c) said MABR device receiving from said session router a further modified said encrypted request including data indicating a redirection to receive said content from said MABR device based upon an encryption key of said MABR device.

2. The method of claim 1 wherein said encrypted request is based upon Hypertext Transfer Protocol Secure.

3. The method of claim 1 wherein said MABR device includes an Internet Protocol address that includes a fully qualified domain name.

4. The method of claim 1 wherein said encrypted request includes a domain name with a transport layer security end-point of said session router.

5. The method of claim 1 wherein said modifying includes additional metadata to said encrypted request identifying said MABR device.

6. The method of claim 1 wherein said modified request is encrypted.
